(19) United States
(12) Patent Application Publication
(10) Pub. No.: US 2021/0169740 A1
(43) Pub. Date: Jun. 10, 2021

(54) MEDICAL TRANSPORT CONTAINER MONITORING USING MACHINE LEARNING

(71) Applicant: Thaddeus Medical Systems, Inc., Rochester, MN (US)

(72) Inventors: Joshua Phillip Janzen, Rochester, MN (US); Russell Sanders, Minnetonka, MN (US)

(21) Appl. No.: 17/116,639

(22) Filed: Dec. 9, 2020

Related U.S. Application Data
(60) Provisional application No. 62/945,410, filed on Dec. 9, 2019.

(51) Int. Cl. A61J 1/16; G06N 20/00

(52) U.S. Cl. CPC A61J 1/165; A61J 2200/44; A61J 2200/72; G06N 20/00

(57) ABSTRACT

Systems and techniques may be used for monitoring a medical transport container. A technique may include, receiving data from a sensor, for example corresponding to a component of a medical transport container. The technique may further include generating a classification model using a machine learning technique, classifying the data using the classification model, and outputting a score from the classification model. The technique may determine whether the score has traversed a threshold value, and responsive to a determination that the score has traversed the threshold value, output an indication related to the operational status of the component of the medical transport container.

### CLAIM OF PRIORITY

This patent application claims the benefit of priority, under 35 U.S.C. Section 119(e), to Josh Janzen U.S. Patent Application Ser. No. 62/945,410, entitled “MEDICAL TRANSPORT CONTAINER MONITORING USING MACHINE LEARNING,” filed on Dec. 11, 2019 (Attorney Docket No. 4394.019PRV) each of which is hereby incorporated by reference herein in its entirety.

### BACKGROUND

Medical transport containers are used when moving temperature sensitive materials, such as blood samples, organs for transplant, or the like. The container is required to maintain a specified temperature or range, which may vary depending on the material being transported. The amount of time the container must maintain the temperature or range varies depending on the distance the material, sample, specimen, or the like is required to travel.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a medical transport container system, in accordance with some embodiments.

FIG. 2 illustrates components and sensors of a medical transport container, in accordance with some embodiments.

FIG. 3. illustrates an example graphical user interface of a medical transport container, according to some embodiments.

FIG. 4 illustrates a flowchart for a method of monitoring a medical transport container, in accordance with some embodiments.

FIG. 5 illustrates training and use of a machine-learning system, according to some example embodiments.

FIG. 6 is a block diagram illustrating an example of a machine upon which one or more embodiments may be implemented, according to some embodiments.

### DETAILED DESCRIPTION

Medical transport containers are used to transport a variety of organic materials or specimens, such as vaccines, blood samples, tissue samples, or organs for transplant. Transport may occur from one hospital to another, from a hospital or clinic to an offside lab, or the like. In the case of transporting organs for transplant, there may be cases when an organ must be transported a substantial distance, including from one state to another, or across multiple states or countries.

In such examples, temperature may be regulated within the container to maintain viability of the transported material. A temperature setpoint or range may vary depending on the material being transported. Often, items being transported may be heat sensitive (e.g., such as certain vaccines) but must not be allowed to freeze. In this example, a temperature range of, for example, forty-five-degrees to fifty-nine-degrees Fahrenheit may be maintained. Some medical transport containers use passive refrigeration systems, which may require frequent replenishing of a cooling source (e.g., an ice pack) to keep the interior of a container within a desired temperature range. Passive containers may also require constant monitoring of their inner temperature to make sure the cooling source being used is maintaining the temperature in a desired range.

A container utilizing an active refrigeration system may be more efficient at keeping the interior of a medical transport container within a desired temperature range for an extended period of time, such as, for example, forty-eight-hours. An active refrigeration system uses multiple components (e.g., a compressor, a drive, a capillary, a refrigerant drier, a fan, a controller, temperature sensors, an accelerometer, a condenser, an evaporator, a battery, a battery charger, or the like) to maintain the desired temperature range within the container.

The components making up an active refrigeration system operate properly when they maintain the desired temperature range for the duration of the transport. A component failure in the system while transporting material may cause the material being transported to be damaged, degraded, or otherwise become unusable.

Disclosed herein are systems and methods that can monitor a medical transport container, specifically, by using a processor to receive data from a sensor, or from a plurality of sensors, corresponding to one or more components of the medical transport container. The plurality of sensors may include two or more of: a compressor current sensor, an accelerometer, a drive signal, an outside air temperature sensor, a fan current sensor, an internal temperature sensor, a high side refrigerant temperature sensor, a high side refrigerant pressure sensor, a low side refrigerant pressure sensor, a battery sensor, a battery charger sensor, or the like.

The data for the component may be classified using a classification model generated using a machine learning technique. Machine learning is a field of study that gives computers the ability to learn without being explicitly programmed. Machine learning generates a model that may learn from existing data and make predictions about new data.

Two common types of problems in machine learning are classification problems and regression problems. Classification problems, also referred to as categorization problems, aim at classifying items into one of several category values (e.g., is this object an apple or an orange, or is this component normal or damaged?). Regression algorithms aim at quantifying some items (for example, by providing a value that is a real number).

In some embodiments, example machine-learning techniques provide a score (e.g., a number from 1 to 100) to quantify the operational status of a component. The machine-learning techniques may use training data or testing data to identify correlations among identified features that affect the outcome, including a prediction.

The machine-learning techniques may use features for analyzing the data to generate assessments. A feature may be an individual measurable property of a phenomenon being observed (e.g., a temperature inside a medical transport container, an amount of charge on a battery, a refrigerant level, a degree of tilt, or the like). The concept of a feature may be related to that of an explanatory variable used in statistical techniques such as linear regression. Features may be of different types, such as numeric features, strings, or graphs.

The machine-learning techniques may use the training data or testing data to find correlations among the identified features that affect the outcome or assessment. With the training data or the testing data and the identified features, the machine-learning model may be trained. The machine-learning model may appraise the value of the features as they correlate to the training data. The result of the training is a trained machine-learning model. When the machine-learning model is used to perform an assessment, new data (e.g., new sensor data) is provided as an input to the trained machine-learning model, and the machine-learning model generates the assessment as output.

In an example, the system may output a score from the classification model for the data received by the sensors and determine whether the score has traversed a threshold value. For example, to determine whether the score is within a range. The classification may indicate whether the temperature within the container is within a range, such as an operational temperature range for a particular material being transported.

In an example, responsive to determining that the score has traversed the threshold value, the system may output an indication related to an operational status of the component. The operational status may indicate that the component is operating within an established tolerance. The operational status may also indicate that the component is operating outside an established tolerance. For example, the operational status may include a status corresponding to the state of a battery. This may include information indicating that the battery has reached a level of charge capable of powering an active refrigeration system for a specified period of time. Said period of time may be a travel time required to transport a particular type of material to a destination. For example, if a particular material requires it remain at a temperature between forty-degrees and fifty-degrees Fahrenheit and is estimated to take seventy-two-hours to reach a destination, the battery may be charged until capable of maintaining that temperature range for at least the entire seventy-two-hour duration. In another example, the duration required may be longer than the estimated travel time so as to provide a buffer should an unexpected delay occur.

The operational status may include information indicating that the battery is draining faster than a specified rate. This may be determined by a machine learning technique utilizing data from multiple components. For example, the status of the battery and the time between charges (e.g., how much time has elapsed since the battery charger was last used) may be used to determine that the battery is draining faster than an established tolerance. An alert may be provided based on the identified issue, such as advising that the battery may need recharging or recommending that the battery be replaced.

The operational status may include a status of a refrigerant level. For example, the indication may include a suggestion to fill refrigerant of the medical transport container at a next servicing in response to an evaluation (e.g., using machine learning) of the status of the refrigerant level. This may be based on the amount of time the system remains in a desired temperature range. In another example, the system may use data from multiple components to make a prediction or a recommendation regarding refrigerant. For example, the system may determine, based on a refrigerant level, and the amount of time has elapsed since the refrigerant was last filled, that there may be a leak in the refrigeration or coolant system of the medical transport container.

Outputting an indication may include illuminating an LED, transmitting a message to a graphical user interface, sending a message to a cloud-based server, an email address, or the like. In another example, the indication may include sounding an audible alarm. The alarm may sound, for example, when an accelerometer connected to the container detects that the container has been tilted greater than a specified number of degrees (e.g., greater than thirty-five-degrees), tilted over a threshold number of degrees a number of times (e.g., over twenty-five-degrees five times), tilted a total time over a specified angle over a time period (e.g., the container spent more than two minutes tilted at over twenty-five-degrees during a ten minute interval), or the like. The angle of tilt can be selected based on a refrigerant system located within the container where the angle is at or near a position where there is a likelihood of trapping oil within the system or otherwise preventing oil from returning to the compressor, which can cause the compressor to burn out. In another example when the accelerometer detects a tilt greater than a specified number of degrees, the compressor may stop, be disengaged, shut off, or otherwise rendered non-operational.

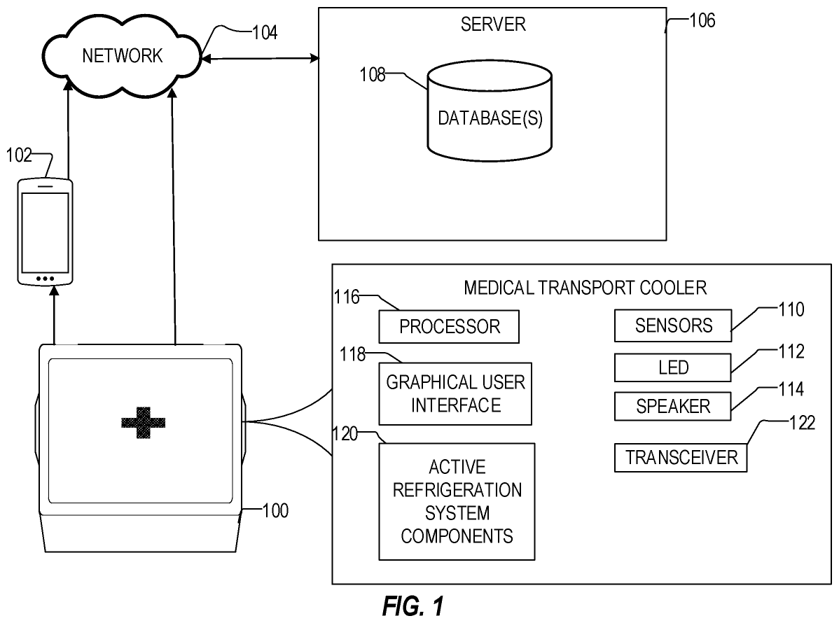

FIG. 1 illustrates a medical transport container system, in accordance with some embodiments. The system includes a medical transport container 100, which may include a processor 116, a graphical user interface 118, a plurality of sensors 110, a light emitting diode (LED) 112, a speaker 114, active refrigeration system components 120, or a transceiver 122. The transceiver 122 may include one or more antennas, for example a Wi-Fi antenna, a BLUETOOTH® antenna, an NFC (near field communication) reader or transmitter, an RFID (radio frequency identification) antenna, a cellular antenna (e.g., 3G, 4G, 5G, etc.), or the like. The transceiver 122 may communicate with a server, such as server 106, which may include an email server to send data, or a remote server. The transceiver 122 may use one or more communication protocols to send data to various devices such as user device 102, which may include a mobile device, a nearby device, a remote server, or the like.

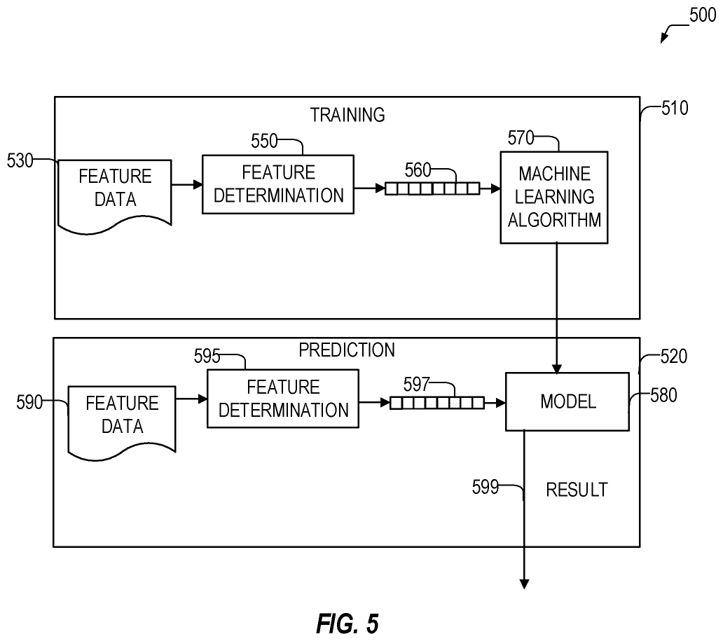

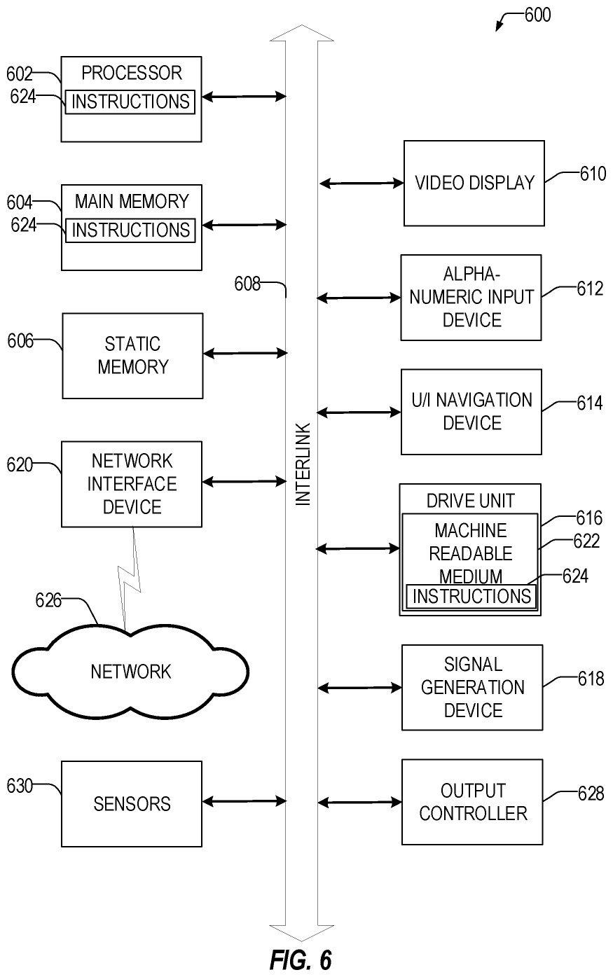

The transceiver 122 may be powered or passive. The transceiver 122 may communicate intermittently (e.g., when there is data to send, such as when a buffer is full, or according to a periodic schedule) or via a continuous connection. A machine learned model such as described for FIG. 5 below may be sent to the medical transport container. In an example, the machine learned model may be received via the transceiver 122 and stored in memory such as described for FIG. 6 below.

The medical transport container 100 may include circuitry to connect to a user device 102 (e.g., a smartphone, a tablet, a notebook computer, a desktop computer, or the like), or to a network 104. The network 104 may include a local area network (LAN), a wide area network (WAN), the internet, or the like. The network 104 may connect to a server 106, which may be a machine described in FIG. 6 below. The server may contain a database 108 in which information regarding the sensors 110, status of the components included in the active refrigeration system components 120, or messages that may be sent to the graphical user interface 118 may be stored.

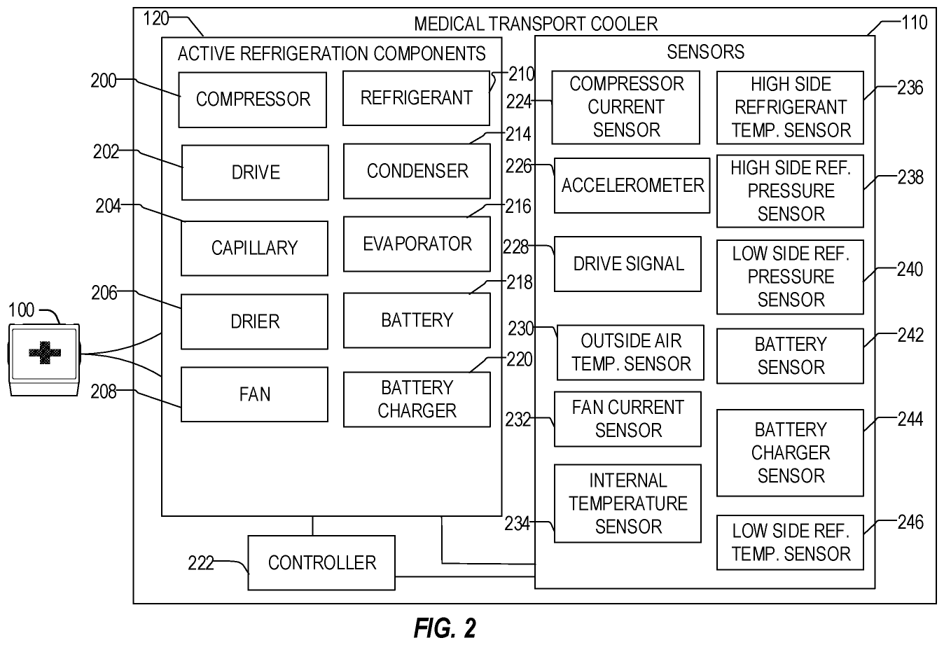

The active refrigeration system components 120, may include: a compressor, a condenser, a drive, an evaporator, a capillary, a drier, a fan, a controller, a battery, refrigerant, or the like, as described further below with respect to FIG. 2. One or more of the components 120 may be connected to respective one or more sensors of the plurality of sensors 110, which may collect data from the components 120. The collected data may be classified using a classification model generated using a machine learning technique such as one of the techniques described in FIG. 5 below.

The medical transport container 100 may connect to the user device 102 in multiple ways. Such as, for example, through a universal serial bus (USB) cable, wireless local area networking (e.g. Wi-Fi), or any similar wireless technology (e.g. BLUETOOTH®). In an example, the medical transport container 100 may connect to the network 104 directly or through the user device 102.

FIG. 2 illustrates the components and sensors of the active refrigeration system of the medical transport container 100, in accordance with some embodiments. In an example, the medical transport container 100 may include active refrigeration components, for example: a compressor 200, a drive 202, a capillary 204, a drier 206, a fan 208, a condenser 214, an evaporator 216, a battery, 218, a battery charger 220, refrigerant 210, or the like. The compressor 202 may be a variable speed drive, which can control the speed of the fan 208, compressor 200, or the like, and may reduce the power consumption of the components 200-220.

The sensors may include: a compressor current sensor 224, an accelerometer 226, a drive signal 228, an outside air temperature sensor 230, a fan current sensor 232, an internal temperature sensor 234, a high side refrigerant temperature sensor 236, a high side refrigerant pressure sensor 238, a low side refrigerant pressure sensor 240, a battery sensor 242, a battery charger sensor 244, a low side refrigerant temperature sensor 246, or the like.

The drive signal 228 may be used to control the speed of the drive 202, which may be a part of a feedback control to maintain a desired threshold value. The drive signal 228 may be connected directly to the drive 202, or the processor 222.

The compressor current sensor 224 can be a current sensor configured to measure current drawn by the compressor 200 during operation thereof. Similarly, the fan current sensor 234 can be a current sensor configured to measure current drawn by the fan 208 during operation thereof. Each of the compressor current sensor 224 and the fan current sensor 234 can be in communication with the controller 222.

The battery sensor 242 may determine the amount of charge currently on the battery 218 (e.g. whether the battery 218 is fully charged). The battery charger sensor 244, may keep track of an amount of time required to charge the battery 218. Each of the battery sensor 242 and the battery charge sensor 244 can be in communication with the controller 222 and may be used to recommend that that the battery 218 be replaced.

The high side refrigerant pressure sensor 238 can be a refrigerant pressure sensor connected to the discharge side of the compressor or between the compressor and the condenser coil. Similarly, the high side refrigerant temperature sensor 236 can be a temperature sensor connected to the discharge side of the compressor or between the compressor and the condenser coil. In some examples, the high side refrigerant pressure and temperature sensors can be positioned downstream of the condenser coil and upstream of an expansion device (capillary tube). In other examples, a refrigerant pressure and temperature sensor can be included downstream of the condenser and upstream of the capillary tube in addition to the high side refrigerant pressure sensor 238 and the high side refrigerant temperature sensor 236.

The low side refrigerant pressure sensor 240 can be a refrigerant pressure sensor connected to the inlet side of the evaporator. Similarly, the low side refrigerant temperature sensor 246 can be a temperature sensor connected to the inlet side of the evaporator. In some examples, a refrigerant pressure sensor and a refrigerant temperature sensor can be included downstream of the evaporator and upstream of the compressor in addition to the low side refrigerant pressure sensor 240 and the low side refrigerant temperature sensor 246.

A controller 222 may be connected to the active refrigeration components 120 or the sensors 110, and may be configured to control aspects of the components 120, for example changing a temperature, causing the battery charger 220 to charge the battery 218, activating or changing speed of the fan 208, etc. In an example, the controller 222 may control aspects of the sensors 110, for example by causing sensor data to be collected or sent to a processor of the medical transport container 100 or to be transmitted to a remote device.

In some examples, the accelerometer 226 may output information indicating that the medical transport container 100 is tilting at an angle known to cause oil to not return completely or partially to the compressor 200. In such a case, the controller 222 can produce an alert, deactivate the compressor 200, and/or increase a speed of the compressor 200 via the drive 202 to increase refrigerant velocity and therefore oil velocity to improve oil return to the compressor 200.

In some examples, the accelerometer 226 may output information indicating that the medical transport container 100 is tilting, but not at an angle which would otherwise cause a problem. However, one or more of the high side refrigerant pressure sensor 236, the high side temperature sensor, 238, the low side pressure sensor 240, and the low side temperature sensor 246 together, the compressor current sensor 224, the ambient air temperature sensor 230, and the temperature sensor 234 (which may be a payload temperature sensor) may output information to the controller 222 that can be analyzed to indicate that thermal performance of the refrigerant system 120 is lower than expected. In such a case, it may be determined that a level of refrigerant 210, which when combined with the tilt, may indicate a problem, such as that oil flow to the compressor is limited at unexpected angles of tilt and manifests immediately or over time through performance degradation of the thermal performance of the system 120. A determination of the problem may occur using a machine learned model that outputs an indication of the problem based on the tilt and refrigerant p inputs. The machine learned model may be run on the medical transport container 100 (e.g., using memory and a processor of the medical transport container 100) or remotely, for example when the input data is sent to a remote device. The results of the machine learned model can be used to update the angle of tilt at which the alarm is produced by the controller 222 and/or the angle of tilt at which the controller 222 deactivates the compressor 200. In examples where a variable speed drive is used to control a speed of the compressor 200, the results of the machine learned model can be used to update a minimum speed of the compressor 200 at various tilts.

One or more of the sensors 224-246 may be used to collect data from one or more of the components 200-220. The collected data may be classified, using a classification model generated using a machine learning technique. From the classification generated from the classification model, a score may be output. A processor (e.g., of the medical transport container 100 or a remote device) may determine whether the score has traversed a threshold value or whether the threshold value is within a particular range. Responsive to determining whether the threshold value is within a range, the classification model may output an indication related to an operational status of a component (e.g., one of 200-220). The operational status may indicate that the component (e.g., one of 200-220) is operating within an established tolerance. In another example, the operational status may indicate that the component is operating outside an established tolerance.

In an example, the data collected from the compressor 200 may include a level of liquid refrigerant 210 within an accumulator of the compressor 200. It may be efficient to keep the amount of refrigerant 210 in the accumulator of the compressor 200 under a desired level (e.g., half filled). Thus, the system may determine that the compressor 200 is operating within an established tolerance when the amount of refrigerant 210 in the accumulator of the compressor 200 is the desired level.

In another example, data from multiple sensors 110 may be combined to determine the operational status of one or more components 200-220. For example, the compressor 200 may only be activated, in an example, when the evaporator 216, the condenser 214, or the drive 202 are each operating within respective threshold value sets. In another example, the speed of the compressor 200 may be based on an ambient temperature as measured by the outside air temperature sensor 230, and controlled by a temperature controller (e.g., controller 222). Similarly, the speed of the fan 208, may be based on the temperature of the condenser 214, which may be determined using on the internal temperature sensor 234. In an example, there may be multiple internal temperature sensors 234 which monitor the temperature of specific components 200-220, or the temperature inside the medical transport container 100. Likewise, the outside air temperature sensor 230 may be affixed to an outer portion of the medical transport container 100 to measure the ambient air temperature surrounding the container 100 or may be located to measure the temperature of the air at the intake of the fan 208.

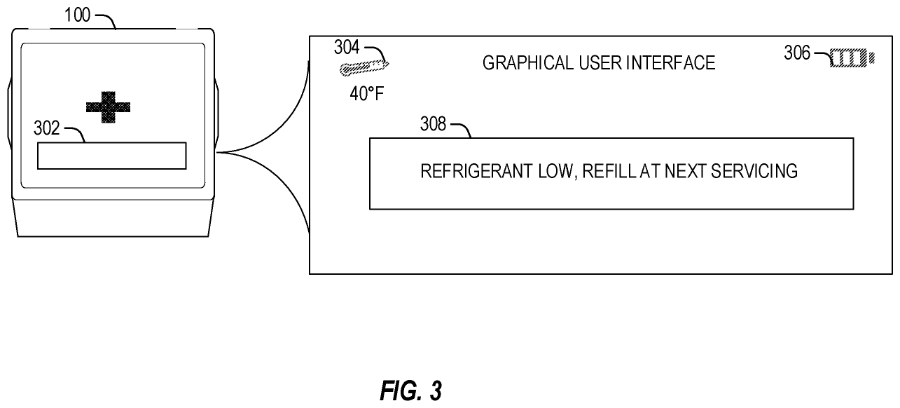

Based on determining the operational status of a component 200-220, the system may output an indication. The indication may be output through a user interface. The user interface may be a graphical user interface located on the medical transport container 100 (such as shown and described in FIG. 3 below) or may be the user interface of a user device such as 102 in FIG. 1 above. The indication may be in the form of a message sent to an email address or to a cloud-based server, such as the server 106 as described in FIG. 1. In another example, the indication may be an audible alarm emitted from a speaker 114 on the medical transport container 100. This example may include an alarm sounding when an accelerometer 226 detects that the medical transport container 100 is tilting greater than a certain number of degrees. When the accelerometer 226 detects that the medical transport container 100 is tilting greater than a certain number of degrees (e.g., fifteen-degrees), the compressor 200 may be disengaged, shut off, or otherwise rendered non-operational until the medical transport container 100 is no longer tilting beyond a threshold angle.

In an example, a machine learning technique may output, based on a certain number of tilts of the container 100 over a period of time (e.g., over a particular angle for a particular number of minutes), or an amount of time that the container 100 has been tilted over a particular angle (e.g., within a timeframe), a notification or indication regarding a status of the container 100. For example, the output may indicate that the container 100 has not operated optimally or within a specified tolerance and that the contents may be spoiled.

The indication may include illuminating an LED 112 located on the container 100. For example, when all components 200-220 are operating within an established tolerance, the LED 112 may be illuminated with a specific color (e.g., green). In another example, when one or more components 200-220 are operating outside an established tolerance, the LED 112 may be illuminated with a different color (e.g., red).

While FIG. 2 lists a number of components 120 and sensors 110, the number and type of components 200-220 and sensors 224-248 are not intended to be limited to those listed. One or more of each of the components 200-220 or the sensors 224-248 may be included in or on the container 100, and one or more of the components 200-220 or sensors 224-248 may be replaced, swapped out, augmented, or the like with another similar sensor or component which may perform a similar function. For example, a gyroscope, an inertial measurement unit (IMU), a piezoelectric vibration sensor, or other similar sensor may be used along with, or in place of, the accelerometer 126. In another example, the container 100 may include more than one internal temperature sensor 234 in order to measure the temperature inside the container 100 or a component 200-220 along with the outside air temperature sensor 230 to determine the temperature of the environment outside the container 100.

FIG. 3 illustrates a graphical user interface of a medical transport container, according to some embodiments. In the example of FIG. 3, a graphical user interface 302 may be mounted, connected, or otherwise coupled to a medical device container 300. In an example, the graphical user interface 302 may be an LCD screen or other similar screen. In another example, the graphical user interface 302, may generated on a display, including optionally a touchscreen.

The graphical user interface 302, may include a temperature indication 304 to display a temperature captured by the internal temperature sensor 234 or the outside air temperature sensor 230. The graphical user interface 302 may further include a battery indicator 306. In this example, the battery indicator 306 may display the extent to which the battery 218 is charged. In another example the battery indicator 306 may indicate that the battery 218 is in the process of charging.

The graphical user interface 300, may include a message display area 308, which may display text indications. For example, the system may display messages regarding the operational status of a component, such as the components 200-220 described in FIG. 2 above. For example, the message display area 308 may display a message such as “refrigerant low, refill at next servicing” or other similar status alerts. In another example, the display area 308 may, based on a machine learning technique, determine that based on a current charge on the battery 218, how fast the battery 218 is discharging, an ambient temperature, and the time remaining to the destination, the battery 218 will not hold enough charge to power the container 100 until delivery, and should be charged or replaced during transit.

In another example, the graphical user interface 302 may include a menu which may be accessed through a touchscreen or through a button coupled to the graphical user interface 302, which may allow for checking the operational status of a component of the system. For example, the temperature inside the container 100, the refrigerant level, an amount of time until the battery is drained, or the like.

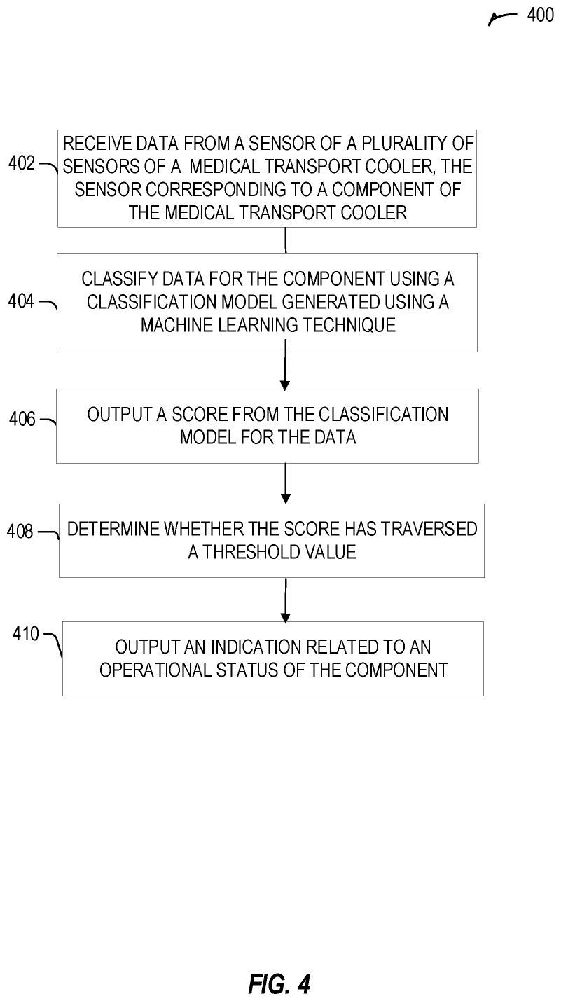

FIG. 4 illustrates a flowchart for a method 400 of monitoring a medical transport container, in accordance with some embodiments. Operation 402 may include receiving data from a sensor of a plurality of sensors of a medical transport container. The sensor may correspond to a component or components (such as components 200-220 as described in FIG. 2) of the medical transport container.

Operation 404 may include classifying data for the component using a classification model generated using a machine learning technique. Operation 406 may include outputting a score from the classification model of operation 404 for the data. For example, the system may output a score for the amount of charge remaining on the battery or the discharge rate. The score may be based on, for example, the material being transported, or an amount of time required to reach a destination. In another example, the method 400 may include outputting a score corresponding to a remaining useful life for the battery 218. This may be based on the amount of time between charges, or a level of charge required to power an active refrigeration system for a specified period of time. The specified period of time may include a travel time required to transport a particular type of material to a destination. In another example, the specified period of time may be the time remaining to a next maintenance servicing of the medical transport container. In another example, the period of time may be longer than an estimated travel time to a destination in order to account for a delay in transporting the material.

Outputting a score from the classification model may include outputting a score corresponding to a refrigerant level. Such a score may be based on the amount of refrigerant 210 compared with a prior level, such as the level after a last maintenance servicing, or a last filling of the refrigerant 210. The score for the refrigerant level may also be based on an amount of time since the refrigerant was last filled.

Operation 408 may include determining whether a score has traversed a threshold value. Such a determination may include whether the score has fallen below a threshold value, such as, for example, whether a score corresponding to the level of refrigerant is below a threshold value and as a result, determine that the refrigerant must be refilled. The determination may also include whether the score has exceeded a threshold value, for example, a determination that a score for the amount of charge on the battery has exceeded a threshold value and as a result, determine that the battery is sufficiently charged. Or, for example, determination the amount of time required to charge the battery 218 has fallen below a threshold value, and as a result determine that replacing the battery 218 is recommended.

Responsive to determining whether the score has traversed a threshold value at operation 408, operation 410 may include an indication related to an operational status of the component. Outputting the indication may include illuminating an LED, transmitting a message to a graphical user interface such as described in FIG. 3 above, sending a message to a cloud-based server, an email address, or the like, or sounding an audible alarm.

The indication may include a message, such as, to refill the refrigerant, or to charge the battery. The message may indicate that the battery is unable to sufficiently hold a charge and should be replaced. In another example, the message may indicate that the refrigerant level is reducing too fast, and that there may be a leak in the refrigeration system.

The indication may include sounding an alarm. An alarm may occur when an accelerometer connected to the container detects that the container has been tilted greater than an established number of degrees (e.g., greater than thirty-five-degrees). In another example, the alarm may sound when the accelerometer, gyroscope, IMU, or similar sensor detects that the container has been titled greater than an established number of degrees for more than an established time period. For example, the alarm may not sound when a tilt for a short period of time (e.g., 1-10 seconds) is detected, suggesting that the container may have been tipped, but immediately returned to a level position. When however, the system detects the container has been tilting for an extended period of time (e.g., greater than 10 seconds), the alarm may sound. Likewise, in such a situation when the container has tilted for an extended period of time, another indication may be sent such as sending a message to a GUI as described above.

In an example, first sensor data may be used to generate a thermal operating efficiency for the medical transport container. Second sensor data may indicate a tilt of the medical transport container, such as with respect to a direction of gravitational force (e.g., angle information may be output from the sensor). The thermal operating efficiency and the tilt may be input to a machine learned model. The model may be used to determine whether to activate a tilt threshold alarm for the medical transport container as an example of operation 406. In an example, when the tilt threshold alarm is activated the compressor 200 may be disengaged. In another example, the indication of operation 410 may be output. The tilt threshold alarm may be activated for the medical transport container based on an output of the machine learned model.

In an example, the thermal operating efficiency may be determined using data from a payload sensor or a refrigerant pressure sensor. In another example, when the tilt threshold alarm is activated, a speed curve of a compressor may be adjusted. The speed curve may be a speed setting of the compressor based on a condensing temperature (e.g. a high-side temperature or low-side temperature), condensing pressure (e.g. a high-side pressure or low-side pressure), ambient temperature, payload temperature, or the like.

In another example, the alarm may sound when the temperature inside the container rises above or falls below a specified temperature. In another example, the alarm may sound when the charge on the battery 218 falls below a certain level. An alarm may sound in response to a battery charge status, or an alarm may sound in response to an indication that the battery 218 is draining too fast and will not sufficiently power the container in a time required to reach a destination. This may be used in conjunction with an indication (e.g., a message) sent to a GUI on the container 100 as described for FIG. 3 above or sent to a user device 102 as described above for FIG. 1.

In another example, the indication may include illuminating the LED 112. The illumination may be a positive indication (e.g., illuminating the LED 112 green) or a negative indication (e.g., illuminating the LED 112 red). For example, when the LED 112 is green, it may indicate that all components are operating within a normal range as established by the threshold value at operation 408. Or, when the LED 112 is red, it may illuminate indicating that one or more component is operating outside a range established by the threshold value at operation 408. In an example a message regarding the operational status of the component may be sent to the graphical user interface 302, or to an email address, the user device 102 (e.g. in an application, as a text alert, or the like), a cloud-based server, or the like. In another example, there may be multiple sets of LEDs which indicate the operational status for individual components 200-220 (e.g., a set of LEDs corresponding to the operational status of the battery 218, a set of LEDs corresponding to the inner temperature of the container 100, or the like).

In another example LED 112 may be illuminated upon activation, or in conjunction with a tilt sensor alarm. Activation of the tilt sensor alarm may cause an indication (e.g., a message) to be sent to an email address, cloud-based server, or the like. Activation of the tilt threshold alarm may cause an audible, alarm to sound.

FIG. 5 shows an example machine learning module 500 according to some examples of the present disclosure. Machine learning module 500 utilizes a training module 510 and a prediction module 520. Training module 510 feeds training feature data information 530 into feature determination module 550. Feature data 530 may be labelled or unlabeled. Feature determination module 550 determines one or more features 560 from this information. Features 560 are a subset of the information input and is information determined to be predictive of a desired result. The machine learning technique 570 produces a model 580 based upon the features 560 and in some examples, the model 580 is refined based upon feedback associated with those features.

In the prediction module 520, feature data 590 may be input to the feature determination module 595. Feature determination module 595 may determine the same set of features or a different set of features as feature determination module 550. In some examples, feature determination module 595 and 550 are the same module. Feature determination module 595 produces features 597, which are input into the model 580 to generate a result 599. The training module 510 may operate in an offline manner to train the score model 580. The prediction module 520, however, may be designed to operate in an online manner. It should be noted that the score model 580 may be periodically updated via additional training and/or user feedback.

The machine learning technique 570 may be selected from among many different potential supervised or unsupervised machine learning techniques. Examples of supervised learning techniques include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, and hidden Markov models. Examples of unsupervised learning algorithms include expectation-maximization algorithms, vector quantization, and information bottleneck method.

In some examples, the machine learning module 500 may be used to predict a leak in the refrigeration system. In these examples, the feature data 530 and 590 may the level of refrigerant and the amount of time since the refrigerant was last refilled. Further, the feature data 530 may include refrigerant levels in particular components of the system, such as the compressor. The result 599 comprises a prediction that there is a leak in the system and may include a prediction as to where in the system the leak is and may further include a recommendation regarding a component which will need to be repaired or replaced.

Similarly, in some examples, the machine learning module 500 may be used to predict the need to replace a battery. In these examples, the feature data 530 and 590 may include current amount of charge on the battery, an amount of time since the battery was last fully charged, or a discharge rate. The result 599 may comprise a prediction that the battery is no longer holding an adequate charge or is discharging too quickly or may include a recommendation that the battery be replaced.

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify commands to be taken by that machine. Machine 600 may implement the GUIs of FIG. 3 and implement the process of FIG. 4 and any process described herein. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 630, such as a global positioning system (GPS) sensor, compass, accelerometer, or other sensor (e.g. sensors 224-248 in FIG. 2). The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 2804, within static memory 606, or within the hardware processor 602 during execution thereof by the machine 600. In an example, one or any combination of the hardware processor 602, the main memory 604, the static memory 606, or the storage device 616 may constitute machine readable media.

The system may, using its processing circuitry and instructions executed by at least one non-transitory machine-readable media, implement any of the methods or phases, such as those described, for example, for FIGS. 1-5 above, or any other methods or phases described herein.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 2800 and that cause the machine 2800 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620. The Machine 600 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 2820 may include one or more physical jacks (e.g., Ethernet, coaxial, or phone jacks) or one or more antennas to connect to the communications network 2826. In an example, the network interface device 2820 may include a plurality of antennas to wirelessly communicate using at least one of single-input multiple-output (SIMO), multiple-input multiple-output (MIMO), or multiple-input single-output (MISO) techniques. In some examples, the network interface device 2820 may wirelessly communicate using Multiple User MIMO techniques.

Example 1 is a machine-readable storage medium having instructions stored thereon, which, when executed by processing circuitry, cause the processing circuitry to: receive data from a sensor of a plurality of sensors of a medical transport container, the sensor corresponding to a component of the medical transport container; classify the data for the component using a classification model generated using a machine learning technique; output a score from the classification model for the data; determine whether the score has traversed a threshold value; and responsive to determining that the score has traversed the threshold value, output an indication related to an operational status of the component.

In Example 2, the subject matter of Example 1 includes, wherein the plurality of sensors include two or more of: a compressor current sensor, an accelerometer, a drive signal, an outside air temperature sensor, a fan current sensor, an internal temperature sensor, a high side refrigerant temperature sensor, a high side refrigerant pressure sensor, a low side refrigerant pressure sensor, a battery sensor, or a battery charger sensor.

In Example 3, the subject matter of Example 2 includes, wherein when a tilt outside an established tolerance is detected using data from the accelerometer, a compressor is disengaged.

In Example 4, the subject matter of Examples 1-3 includes, wherein to determine whether the score has traversed a threshold value includes determining whether the score is within a range.

In Example 5, the subject matter of Examples 1-4 includes, wherein the operational status indicates that the component is operating within an established tolerance.

In Example 6, the subject matter of Examples 1-5 includes, wherein the operational status indicates that the component is operating outside an established tolerance.

In Example 7, the subject matter of Examples 1-6 includes, wherein outputting the indication includes illuminating an LED of the medical transport container.

In Example 8, the subject matter of Examples 1-7 includes, wherein outputting the indication includes transmitting a message to a graphical user interface.

In Example 9, the subject matter of Examples 1-8 includes, wherein outputting the indication includes sending the indication to an email address or to a cloud-based server.

In Example 10, the subject matter of Examples 1-9 includes, wherein outputting the indication includes sounding an audible alarm.

In Example 11, the subject matter of Example 10 includes, wherein the alarm sounds when an accelerometer detects a tilt outside an established tolerance.

In Example 12, the subject matter of Examples 1-11 includes, wherein the operational status includes a status corresponding to a state of a battery.

In Example 13, the subject matter of Example 12 includes, wherein the operational status includes an information indicating that the battery has reached a level of charge capable of powering an active refrigeration system for a specified period of time.

In Example 14, the subject matter of Examples 12-13 includes, wherein the operational status includes an information indicating that the battery is draining faster than a specified rate.

In Example 15, the subject matter of Example 14 includes, wherein the indication further includes a recommendation to recharge or replace the battery.

In Example 16, the subject matter of Examples 1-15 includes, wherein the operational status includes a status of a refrigerant level.

In Example 17, the subject matter of Example 16 includes, wherein the indication includes a suggestion to fill refrigerant of the medical transport container at next servicing in response to the status of the refrigerant level.

In Example 18, the subject matter of Examples 16-17 includes, wherein the operational status indicates a leak in a cooling system of the medical transport container.

Example 19 is a method for monitoring a medical transport container, the method comprising: receiving data from a sensor of a plurality of sensors of the medical transport container, the sensor corresponding to a component of the medical transport container; classifying the data for the component using a classification model generated using a machine learning technique; outputting a score from the classification model for the data; determining whether the score has traversed a threshold value; and responsive to determining that the score has traversed a threshold value, outputting an indication related to an operational status of the component.

Example 20 is a system for monitoring a medical transport container, the system comprising: an active refrigeration system; a processor; memory including instructions stored thereon which, when executed by the processor, cause the processor to: receive data from a sensor of plurality of sensors of the medical transport container, the sensor corresponding to a component the medical transport container; classify the data for the component using a classification model generated using a machine learning technique; output a score from the classification model for the data; determine whether the score has traversed a threshold value; and responsive to determining that the score has traversed the threshold value, output an indication related to the operational status of the component.

In Example 21, the subject matter of Example 20 includes, wherein the plurality of sensors include two or more of: a compressor current sensor, an accelerometer, a drive signal, an outside air temperature sensor, a fan current sensor, an internal temperature sensor, a high side refrigerant temperature sensor, a high side refrigerant pressure sensor, a low side refrigerant pressure sensor, a battery sensor, or a battery charger sensor.

Example 22 is a machine-readable storage medium having instructions stored thereon, which, when executed by processing circuitry, cause the processing circuitry to: receive data from a first sensor of a plurality of sensors of a medical transport container, the sensor corresponding to a component of the medical transport container; generate, using the received data, a thermal operating efficiency for the medical transport container; receive data from a second sensor of the plurality of sensors indicating a tilt of the medical transport container with respect to a direction of gravitational force; input the thermal operating efficiency and the tilt to a machine learned model to determine whether to activate a tilt threshold alarm for the medical transport container; and activate the tilt threshold alarm for the medical transport container based on an output of the machine learned model.

In Example 23, the subject matter of Example 22 includes, wherein the processing circuitry is further caused to: disengage a compressor when the tilt threshold alarm is activated.

In Example 24, the subject matter of Examples 22-23 includes, wherein the first sensor includes a payload temperature sensor or a refrigerant pressure sensor.

In Example 25, the subject matter of Examples 22-24 includes, wherein the processing circuitry is further caused to: adjust a speed curve of a compressor when the tilt threshold alarm is activated.

In Example 26, the subject matter of Examples 22-25 includes, wherein the second sensor includes an accelerometer.

In Example 27, the subject matter of Examples 22-26 includes, wherein to activate the tilt threshold alarm, the processing circuitry is further caused to illuminate an LED of the medical transport container.

In Example 28, the subject matter of Examples 22-27 includes, wherein to activate the tilt threshold alarm, the processing circuitry is further caused to transmit a message to a graphical user interface.

In Example 29, the subject matter of Examples 22-28 includes, wherein to activate the tilt threshold alarm, the processing circuitry is further caused to send the indication to an email address or to a cloud-based server.

In Example 30, the subject matter of Examples 22-29 includes, wherein to activate the tilt threshold alarm, the processing circuitry is further caused to sound an audible alarm.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A machine-readable storage medium having instructions stored thereon, which, when executed by processing circuitry, cause the processing circuitry to:
receive data from a sensor of a plurality of sensors of a medical transport container, the sensor corresponding to a component of the medical transport container;
classify the data for the component using a classification model generated using a machine learning technique;
output a score from the classification model for the data;
determine whether the score has traversed a threshold value; and
responsive to determining that the score has traversed the threshold value, output an indication related to an operational status of the component.

2. The machine-readable medium of claim 1, wherein the plurality of sensors include two or more of: a compressor current sensor, an accelerometer, a drive signal, an outside air temperature sensor, a fan current sensor, an internal temperature sensor, a high side refrigerant temperature sensor, a high side refrigerant pressure sensor, a low side refrigerant pressure sensor, a battery sensor, or a battery charger sensor.

3. The machine-readable medium of claim 2, wherein when a tilt outside an established tolerance is detected using data from the accelerometer, a compressor is disengaged.

4. The machine-readable medium of claim 1, wherein to determine whether the score has traversed a threshold value includes determining whether the score is within a range.

5. The machine-readable medium of claim 1, wherein the operational status indicates that the component is operating within an established tolerance.

6. The machine-readable medium of claim 1, wherein the operational status indicates that the component is operating outside an established tolerance.

7. The machine-readable medium of claim 1, wherein outputting the indication includes illuminating an LED of the medical transport container.

8. The machine-readable medium of claim 1, wherein outputting the indication includes transmitting a message to a graphical user interface.

9. The machine-readable medium of claim 1, wherein outputting the indication includes sending the indication to an email address or to a cloud-based server.

10. The machine-readable medium of claim 1, wherein outputting the indication includes sounding an audible alarm.

11. The machine-readable medium of claim 10, wherein the alarm sounds when an accelerometer detects a tilt outside an established tolerance.

12. The machine-readable medium of claim 1, wherein the operational status includes a status corresponding to a state of a battery.

13. The machine-readable medium of claim 12, wherein the operational status includes an information indicating that the battery has reached a level of charge capable of powering an active refrigeration system for a specified period of time.

14. The machine-readable medium of claim 12, wherein the operational status includes an information indicating that the battery is draining faster than a specified rate.

15. The machine-readable medium of claim 14, wherein the indication further includes a recommendation to recharge or replace the battery.

16. The machine-readable medium of claim 1, wherein the operational status includes a status of a refrigerant level.

17. The machine-readable medium of claim 16, wherein the indication includes a suggestion to fill refrigerant of the medical transport container at next servicing in response to the status of the refrigerant level.

18. The machine-readable medium of claim 16, wherein the operational status indicates a leak in a cooling system of the medical transport container.

19. A method for monitoring a medical transport container, the method comprising:
receiving data from a sensor of a plurality of sensors of the medical transport container, the sensor corresponding to a component of the medical transport container;
classifying the data for the component using a classification model generated using a machine learning technique;
outputting a score from the classification model for the data;
determining whether the score has traversed a threshold value; and
responsive to determining that the score has traversed a threshold value, outputting an indication related to an operational status of the component.

20. A system for monitoring a medical transport container, the system comprising:
an active refrigeration system;
a processor;
memory including instructions stored thereon which, when executed by the processor, cause the processor to:
receive data from a sensor of plurality of sensors of the medical transport container, the sensor corresponding to a component the medical transport container;
classify the data for the component using a classification model generated using a machine learning technique;
output a score from the classification model for the data;
determine whether the score has traversed a threshold value; and
responsive to determining that the score has traversed the threshold value, output an indication related to the operational status of the component.
